(19) United States
(12) Patent Application Publication
(10) Pub. No.: US 2002/0103800 A1
(43) Pub. Date: Aug. 1, 2002

(54) Method and apparatus for system administration using a portable computing device

(76) Inventor: Russell C. Hay, Kirkland, WA (US)

Correspondence Address: PARK, VAUGHAN & FLEMING LLP, 508 SECOND STREET, SUITE 201, DAVIS, CA, 95616, US

(21) Appl. No.: 09/773,849

(22) Filed: Jan. 31, 2001

(51) Int. Cl. G06F 7/00

(52) U.S. Cl. 707/9

(57) ABSTRACT

One embodiment of the present invention provides a system for entering system administration data using a portable computing device, wherein the portable computing device may not be able to access an associated system during data entry. The system operates by first allowing a system administrator to access a data entry program on the portable computing device. This data entry program accepts an element of system administration data from the system administrator, wherein the element of system administration data can be used by the associated system to generate system administration commands. At a later time, when the portable computing device is able to access the associated system, the element of system administration data is transferred from the data entry program to the associated system so that an associated system administration function can be performed on the associated system

### BACKGROUND

1. Field of the Invention

The present invention relates to administration of computer systems. More specifically, the present invention relates to administration of computer systems by using a portable computing device for entering system administration data into and later synchronizing the portable computing device with an associated computing device to be administered.

2. Related Art

System administrators enter many commands in order to administer various aspects of a computer system, including commands to perform event administration, account administration, and package administration.

Event administration includes administrating time-based actions, such as scheduling file back-ups, which occur daily, weekly or at some other interval. Event administration also includes scheduling one-time events that occur at some time in the future.

Account administration includes creating accounts for new users, assigning and changing passwords for users, allocating system storage space for users, and deleting accounts for users who are no longer authorized to use the computer system.

Package administration includes scheduling the installation of new software packages, scheduling updates to existing software packages, and allowing user access to the packages installed on the system.

Typically, a system administrator uses a computing device that is coupled directly or through a network to the computing system to be administered in order to enter commands to administer events, accounts, and packages. However, many times, a system administrator may not have access to a computer system but may, nevertheless, have data to be entered into the computer system. In these situations, for instance during an airplane flight, the system administrator must either write the data on paper or remember the data in order to have it available when the system administrator is able to access the computing device.

What is needed is a method and an apparatus that allows a system administrator to enter system administration data even though the system to be administered is not directly accessible.

### SUMMARY

One embodiment of the present invention provides a system for entering system administration data using a portable computing device, wherein the portable computing device may not be able to access an associated system during data entry. The system operates by first allowing a system administrator to access a data entry program on the portable computing device. This data entry program accepts an element of system administration data from the system administrator, wherein the element of system administration data can be used by the associated system to generate system administration commands. At a later time, when the portable computing device is able to access the associated system, the element of system administration data is transferred from the data entry program to the associated system so that an associated system administration function can be performed on the associated system.

In one embodiment of the present invention, the element of system administration data includes data to generate event management commands.

In one embodiment of the present invention, the element of system administration data includes data to generate account management commands.

In one embodiment of the present invention, the element of system administration data includes data to generate package management commands.

In one embodiment of the present invention, establishing communication between the portable computing device and the associated system includes establishing communication between the portable computing device and a local system. After the portable computing device has established communications with the local system, the portable computing device transfers the element of system administration data from the portable computing device to the local system. The local system then translates the element of system administration data from a format used by the portable computing device to a second format used by the associated system. Next, the local system communicates with the associated system through a network in order to transfer the element of system administration data to the associated system.

In one embodiment of the present invention, the system transfers existing system administration data from the associated system to the portable computing device to allow the system administrator to modify existing system administration data.

In one embodiment of the present invention, the system administrator is allowed to delete existing system administration data.

In one embodiment of the present invention, the data entry program accepts a password from the system administrator. After accepting the password, the data entry program verifies the password prior to allowing the system administrator to enter system administration data.

### BRIEF DESCRIPTION OF THE FIGURES

FIG. 1 illustrates computing devices coupled together in accordance with an embodiment of the present invention.

FIG. 2 is a flowchart illustrating the process of determining the type of transaction being processed in accordance with an embodiment of the present invention.

FIG. 3 is a flowchart illustrating the process of handling an event transaction in accordance with an embodiment of the present invention.

FIG. 4 is a flowchart illustrating the process of handling an account transaction in accordance with an embodiment of the present invention.

FIG. 5 is a flowchart illustrating the process of handling an package transaction in accordance with an embodiment of the present invention.

FIG. 6 is a flowchart illustrating the process of synchronizing the portable computing device with an associated system in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computing Devices

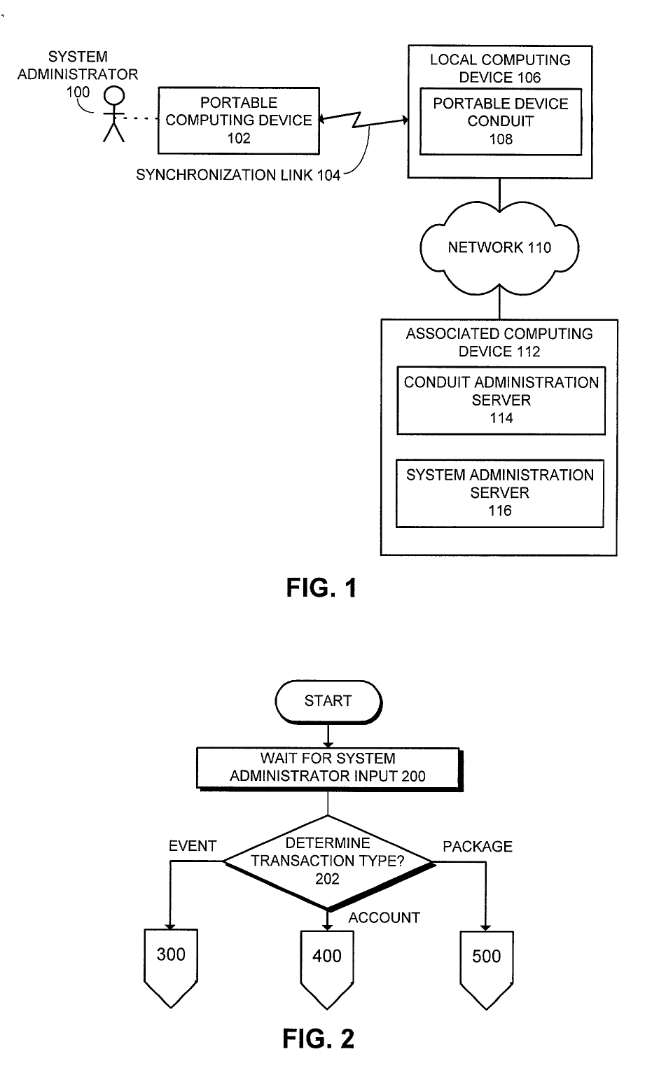

FIG. 1 illustrates computing devices coupled together in accordance with an embodiment of the present invention. System administrator 100 uses portable computing device 102 to enter various system administration data, such as event data, account data, and package data. This system administration data can be used by an associated computer system to generate system administration commands. Portable computing device 102 can generally include any type of portable computer system, including, but not limited to, a computer system based on a microprocessor, a digital signal processor, a personal organizer, a personal digital assistant, a device controller, and a computational engine within an appliance. Typically, the system administrator uses a personal digital assistant such as the PALM^{™} handheld computing device for entering the system administration data.

Local computing device 106 and associated computing device 112 can generally include any type of computer system, including, but not limited to, a computer system based on a microprocessor, a mainframe computer, a digital signal processor, a portable computing device, a personal organizer, a device controller, and a computational engine within an appliance. In one embodiment of the present invention, local computing device 106 is a desktop personal computer and associated computing device 112 is a computing device.

During operation, local computing device 106 and associated computing device 112 are coupled together across network 110. Network 110 can generally include any type of wire or wireless communication channel capable of coupling together computing nodes. This includes, but is not limited to, a local area network, a wide area network, or a combination of networks. In one embodiment of the present invention, network 110 includes the Internet. Communications across network 110 may be encrypted to ensure data security and integrity.

When system administrator 100 desires to synchronize portable computing device 102 with associated computing device 112, system administrator 100 establishes synchronization link 104 between portable computing device 102 and local computing device 106. Synchronization link 104 can generally include any type of wire or wireless communication channel capable of coupling together computing nodes. Synchronization link 104 is typically established using a wired channel or an infra-red communications channel.

Local computing device 106 includes portable device conduit 108. Portable device conduit 108 communicates with portable computing device 102 across synchronization link 104 and with associated computing device 112 across network 110. Portable device conduit 108 performs any necessary translations between the data formats used on portable computing device 102 and the data formats used on associated computing device 112. Portable device conduit 108 transfers data between portable computing device 102 and associated computing device 112 such that, upon synchronization, both devices share the same data.

Associated computing device 112 includes conduit administration server 114 and system administration server 116. Conduit administration server 114 communicates with local computing device 106 across network 110 in order to accept data entered on portable computing device 102 and to send data to portable computing device 102 from system administration server 116.

System administration server 116 accepts system administration data entered on portable computing device 102 and generates system administration commands to perform system administrator 100's commands.

Transaction Type Determination

FIG. 2 is a flowchart illustrating the process of determining the type of transaction being processed in accordance with an embodiment of the present invention. This process commences when system administrator 100 starts a data entry program on portable computing device 102. The data entry program waits for input from system administrator 100 (200). When system administrator 100 supplies input, the data entry program determines if the transaction type is for an event, an account, or a package (202).

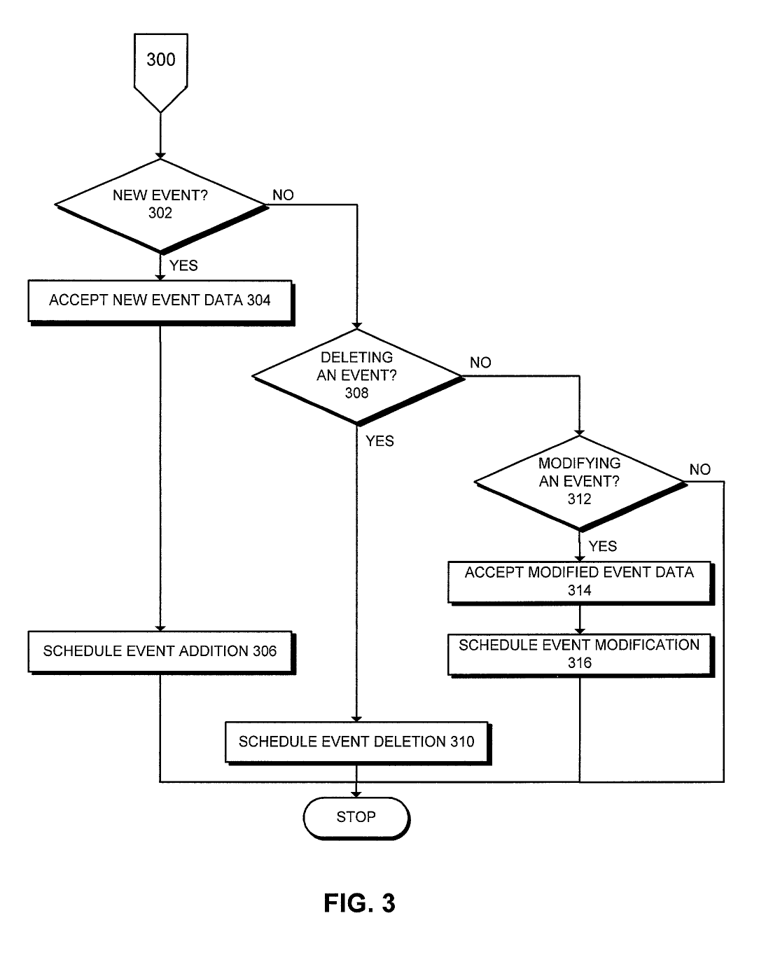

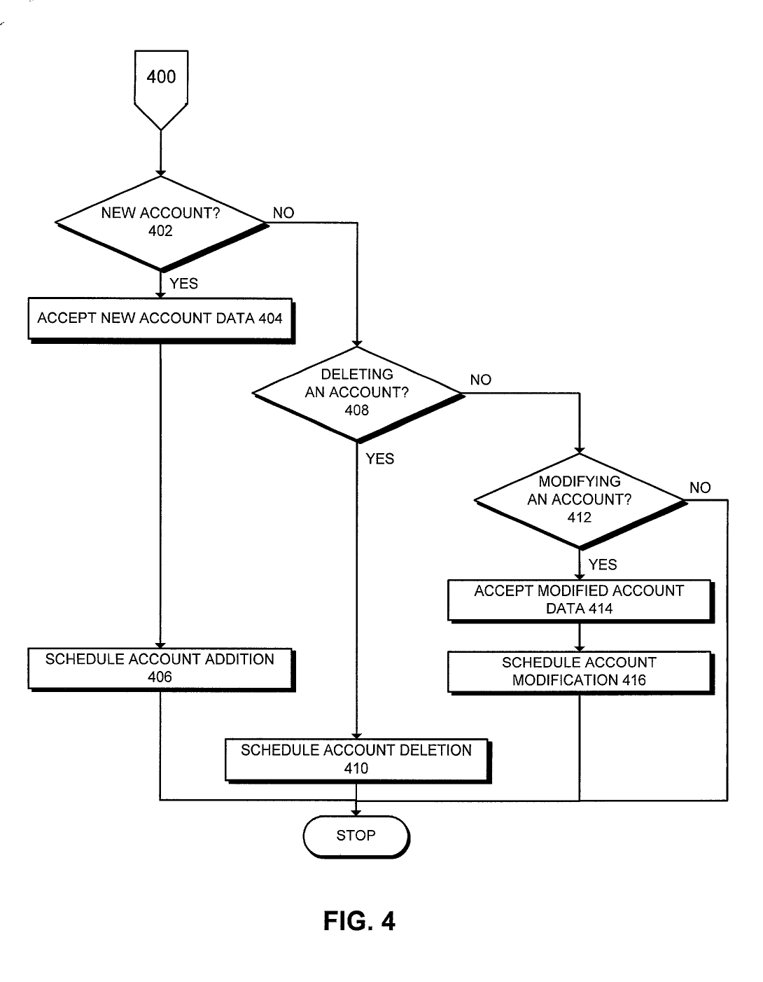

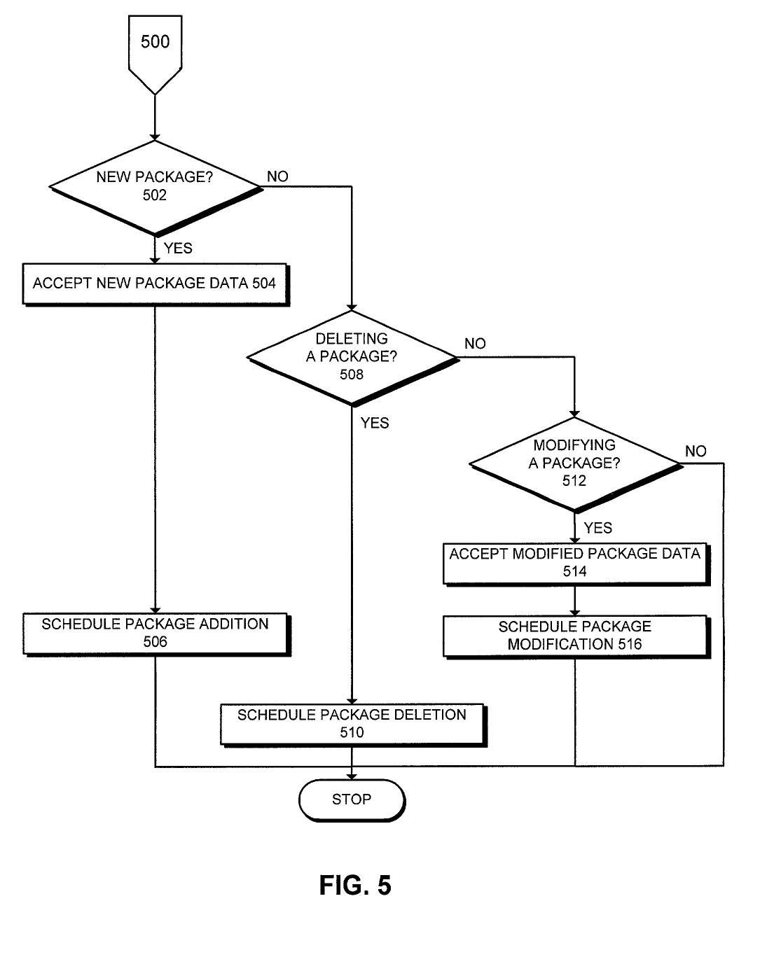

If the transaction type is an event, processing continues at off-page connector 300 as described below in conjunction with FIG. 3. If the transaction type is an account, processing continues at off-page connector 400 as described below in conjunction with FIG. 4. If the transaction type is a package, processing continues at off-page connector 500 as described below in conjunction with FIG. 5.

Processing an Event Transaction

FIG. 3 is a flowchart illustrating the process of handling an event transaction in accordance with an embodiment of the present invention. The system starts when the data entry program on portable computing device 102 determines if the entered data relates to a new event (302). If the entered data relates to a new event, the data entry program accepts the new event data (304). After accepting the new event data, the data entry program schedules the addition of the new event for the next system synchronization (306).

If the entered data does not relate to a new event at 302, the data entry program determines if the entered data relates to deleting an event (308). If the entered data relates to deleting an event, the data entry program schedules the deletion of the event for the next system synchronization (310).

If the entered data does not relate to deleting an event at 308, the data entry program determines if the entered data relates to modifying an existing event (312). If the entered data relates to modifying an existing event, the data entry program accepts the modified event data (314). After accepting the modified event data, the data entry program schedules the modification of the existing event for the next system synchronization (316). If the entered data does not relate to modifying an existing event at 312, or after scheduling the activities at 306, 310, or 316, the process is complete.

Processing an Account Transaction

FIG. 4 is a flowchart illustrating the process of handling an account transaction in accordance with an embodiment of the present invention. The system starts when the data entry program on portable computing device 102 determines if the entered data relates to a new account (402). If the entered data relates to a new account, the data entry program accepts the new account data (404). After accepting the new account data, the data entry program schedules the addition of the new account for the next system synchronization (406).

If the entered data does not relate to a new account at 402, the data entry program determines if the entered data relates to deleting an account (408). If the entered data relates to deleting an account, the data entry program schedules the deletion of the account for the next system synchronization (410).

If the entered data does not relate to deleting an account at 408, the data entry program determines if the entered data relates to modifying an existing account (412). If the entered data relates to modifying an existing account, the data entry program accepts the modified account data (414). After accepting the modified account data, the data entry program schedules the modification of the existing account for the next system synchronization (416). If the entered data does not relate to modifying an existing account at 412, or after scheduling the activities at 406, 410, or 416, the process is complete.

Processing a Package Transaction

FIG. 5 is a flowchart illustrating the process of handling a package transaction in accordance with an embodiment of the present invention. The system starts when the data entry program on portable computing device 102 determines if the entered data relates to a new package (502). If the entered data relates to a new package, the data entry program accepts the new package data (504). After accepting the new package data, the data entry program schedules the addition of the new package for the next system synchronization (506).

If the entered data does not relate to a new package at 502, the data entry program determines if the entered data relates to deleting a package (508). If the entered data relates to deleting a package, the data entry program schedules the deletion of the package for the next system synchronization (510).

If the entered data does not relate to deleting a package at 508, the data entry program determines if the entered data relates to modifying an existing package (512). If the entered data relates to modifying an existing package, the data entry program accepts the modified package data (514). After accepting the modified package data, the data entry program schedules the modification of the existing package for the next system synchronization (516). If the entered data does not relate to modifying an existing package at 512, or after scheduling the activities at 506, 510, or 516, the process is complete.

Synchronizing with the Associated Computing Device

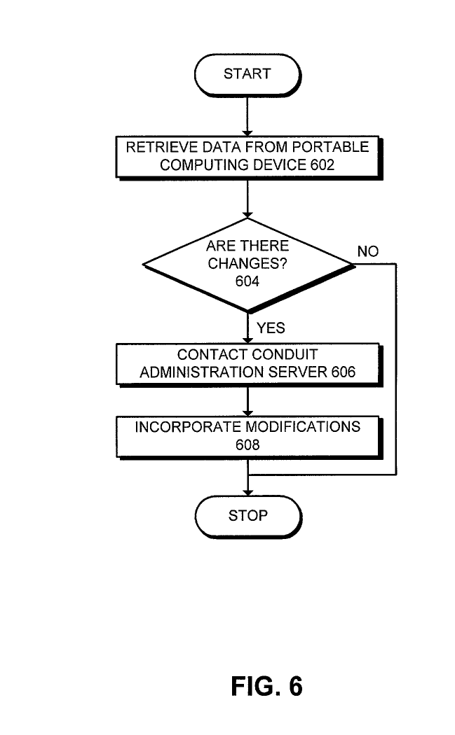

FIG. 6 is a flowchart illustrating the process of synchronizing the portable computing device with an associated system in accordance with an embodiment of the present invention. The system starts when system administrator 100 establishes synchronization link 104 between portable computing device 102 and local computing device 106. Portable device conduit 108 first retrieves scheduled data from portable computing device 102 (602). Next, portable device conduit 108 determines if there have been any changes to the system data (604). If there have been changes, portable device conduit 108 contacts conduit administration server 114 across network 110 (606). Conduit administration server 114 then incorporates the modified system administration data into system administration server 116 (608). After incorporating the modified system administration data into system administration server 116 or if there are no changes at 604, the process is complete.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for entering system administration data using a portable computing device, wherein the portable computing device may not be able to access an associated system to be administered during data entry, comprising:
providing access to a data entry program to a system administrator using the portable computing device;
accepting an element of system administration data into the data entry program from the system administrator, wherein the element of system administration data can be used by the associated system to generate system administration commands;
establishing communication between the portable computing device and the associated system at a later time; and
transferring the element of system administration data from the data entry program to the associated system so that an associated system administration function can be performed on the associated system.

2. The method of claim 1, wherein the element of system administration data includes data to generate event management commands.

3. The method of claim 1, wherein the element of system administration data includes data to generate account management commands.

4. The method of claim 1, wherein the element of system administration data includes data to generate package management commands.

5. The method of claim 1, wherein establishing communication between the portable computing device and the associated system includes:
establishing communication between the portable computing device and a local system;
transferring the element of system administration data from the portable computing device to the local system;
translating the element of system administration data from a format used by the portable computing device to a second format used by the associated system;
establishing communications between the local system and the associated system through a network; and
transferring the element of system administration data from the local system to the associated system.

6. The method of claim 1, further comprising transferring existing system administration data from the associated system to the portable computing device to allow the system administrator to modify existing system administration data.

7. The method of claim 6, further comprising allowing the system administrator to delete existing system administration data.

8. The method of claim 1, further comprising:
receiving a password from the system administrator; and
verifying the password prior to accepting the element of system administration data.

9. A computer-readable storage medium storing instructions that when executed by a computer cause the computer to perform a method for entering system administration data using a portable computing device, wherein the portable computing device may not be able to access an associated system to be administered during data entry, comprising:
providing access to a data entry program to a system administrator using the portable computing device;
accepting an element of system administration data into the data entry program from the system administrator, wherein the element of system administration data can be used by the associated system to generate system administration commands;
establishing communication between the portable computing device and the associated system at a later time; and
transferring the element of system administration data from the data entry program to the associated system so that an associated system administration function can be performed on the associated system.

10. The computer-readable storage medium of claim 9, wherein the element of system administration data includes data to generate event management commands.

11. The computer-readable storage medium of claim 9, wherein the element of system administration data includes data to generate account management commands.

12. The computer-readable storage medium of claim 9, wherein the element of system administration data includes data to generate package management commands.

13. The computer-readable storage medium of claim 9, wherein establishing communication between the portable computing device and the associated system includes:
establishing communication between the portable computing device and a local system;
transferring the element of system administration data from the portable computing device to the local system;
translating the element of system administration data from a format used by the portable computing device to a second format used by the associated system;
establishing communications between the local system and the associated system through a network; and
transferring the element of system administration data from the local system to the associated system.

14. The computer-readable storage medium of claim 9, the method further comprising transferring existing system administration data from the associated system to the portable computing device to allow the system administrator to modify existing system administration data.

15. The computer-readable storage medium of claim 14, the method further comprising allowing the system administrator to delete existing system administration data.

16. The computer-readable storage medium of claim 9, the method further comprising:
receiving a password from the system administrator; and
verifying the password prior to accepting the element of system administration data.

17. An apparatus that facilitates entering system administration data using a portable computing device, wherein the portable computing device may not be able to access an associated system to be administered during data entry, comprising:
an accepting mechanism within the portable computing device that is configured to accept an element of system administration data into the data entry program from the system administrator, wherein the element of system administration data can be used by the associated system to generate system administration commands;
a communications mechanism that is configured to establish communications between the portable computing device and the associated system at a later time; and
a transferring mechanism that is configured to transfer the element of system administration data from the data entry program to the associated system so that an associated system administration function can be performed on the associated system.

18. The apparatus of claim 17, wherein the element of system administration data includes data to generate event management commands.

19. The apparatus of claim 17, wherein the element of system administration data includes data to generate account management commands.

20. The apparatus of claim 17, wherein the element of system administration data includes data to generate package management commands.

21. The apparatus of claim 17, wherein the communication mechanism includes:
a first communication establishing mechanism that is configured to establish communications between the portable computing device and a local system;
a first transferring mechanism that is configured to transfer the element of system administration data from the portable computing device to the local system;
a translating mechanism that is configured to translate the element of system administration data from a format used by the portable computing device to a second format used by the associated system;
a second communication establishing mechanism that is configured to establish communications between the local system and the associated system through a network; and
a second transferring mechanism that is configured to transfer the element of system administration data from the local system to the associated system.

22. The apparatus of claim 17, further comprising a third transferring mechanism that is configured to transfer existing system administration data from the associated system to the portable computing device to allow the system administrator to modify existing system administration data.

23. The apparatus of claim 22, further comprising a deleting mechanism that is configured to allow the system administrator to delete existing system administration data.

24. The apparatus of claim 17, further comprising:
a receiving mechanism that is configured to receive a password from the system administrator; and
a verifying mechanism that is configured to verify the password prior to accepting the element of system administration data.
